(19) United States
(12) Patent Application Publication
(10) Pub. No.: US 2020/0086446 A1
(43) Pub. Date: Mar. 19, 2020

(54) CARRIER STRUCTURE OF WOODWORKING MACHINE SPINDLE

(71) Applicant: CHUN JEN HSU, TAICHUNG CITY (TW)

(72) Inventor: CHUN JEN HSU, TAICHUNG CITY (TW)

(21) Appl. No.: 16/416,457

(22) Filed: May 20, 2019

(30) Foreign Application Priority Data
Sep. 14, 2018 (TW) 107212573

(51) Int. Cl. B23Q 17/22; B27F 1/08

(52) U.S. Cl. CPC B23Q 17/2233; B27F 1/08

(57) ABSTRACT

A carrier structure of a woodworking machine spindle has a base and a sliding seat slidably disposed on the base. The sliding seat is moveable in a z-axis direction relative to the base. The sliding seat includes a carrier that is movable in an x-axis direction or in a y-axis direction. The sliding seat includes a position indicator for detecting and displaying the value of the movement of the carrier in the x-axis direction. The carrier includes a spindle. Two infrared aligners are disposed on two adjacent sides of the carrier. The two infrared aligners are spaced apart from each other at an angle of 90 degrees. The two infrared aligners cooperate with the position indicator to ensure the machining accuracy.

### FIELD OF THE INVENTION

The present invention relates to a carrier structure for a spindle, and more particularly to a carrier structure of a woodworking machine spindle.

### BACKGROUND OF THE INVENTION

In these days, DIY has become more and more popular. Many people may purchase small woodworking machines for making wooden furniture such as tables, chairs, cabinets, boxes, etc. In manufacture, the workpieces are first cut to have tensons and mortises so as to join or lock the parts together for the assembly of the furniture.

However, in practical applications, the tensons and mortises are often machined to have a skew angle. Such a workpiece for a skew angle is first done by drawing the center point of the end face to be machined with a pen, and then it is done undergoing complicated calculations and continuous tries. The machining process is cumbersome, the failure rate is high, and the precision of the finished products may be low.

### SUMMARY OF THE INVENTION

The primary object of the present invention is to provide a carrier structure of a woodworking machine spindle, which can quickly calculate the position of the center point of the skew angle for subsequent machining and is advantageous for the cutting operation of the skew angle to ensure its machining accuracy.

In order to achieve the above object, the present invention comprises a carrier structure of a woodworking machine spindle, comprising a base, a sliding seat, and a carrier. The sliding seat has a top surface and a bottom surface. The bottom surface of the sliding seat is slidably disposed on the base. The sliding seat is moveable in a z-axis direction relative to the base. The top surface of the sliding seat is provided with at least two longitudinal guide poles arranged in parallel. Two longitudinal sliders are slidably disposed on the two longitudinal guide poles so that the two longitudinal sliders are movable along the two longitudinal guide poles in an x-axis direction. At least one transverse guide pole is connected between the two longitudinal sliders. A top frame is transversely fixed to top ends of the two longitudinal guide poles. The top frame is provided with a lifting screw rod extending in the x-axis direction. A template seat is disposed at a lower end of the lifting screw rod passing through the top frame. The template seat is provided with a position indicator. The lifting screw rod passes through the position indicator to be connected to the template seat. Two opposite sides of the template seat are slidably connected to the two longitudinal guide poles. Rotating the lifting screw rod drives the template seat to move along the two longitudinal guide poles. The carrier has a transverse slider. The transverse slider of the carrier is slidably connected to the transverse guide pole so that the carrier is moveable in the x-axis direction along with the two longitudinal sliders or in a y-axis direction along with the transverse guide pole. A bottom of the carrier is connected with a spindle holder. The spindle holder is provided with a spindle. Two infrared aligners are disposed on two adjacent sides of the carrier. The two infrared aligners are spaced apart from each other at an angle of 90 degrees.

### BRIEF DESCRIPTION OF THE DRAWINGS

FIG. 1 is a perspective view of the present invention;

FIG. 2 is an exploded view of the present invention;

FIG. 3 is a rear view of the present invention;

FIG. 4 is a schematic view of the present invention when in use, showing that the carrier is moved forward along with the sliding seat in the z-axis direction;

FIG. 5 is a schematic view of the present invention when in use, showing that the carrier is moved downward in the x-axis direction;

FIG. 6 is a schematic view of the present invention when in use, showing that the carrier is moved rightward in the y-axis direction;

FIG. 7 is a schematic view showing that the present invention is used for cutting a tenon with a skew angle;

FIG. 8 is a schematic view showing that the present invention is used for machining a dovetail-shaped tenon; and

FIG. 9 and FIG. 10 are schematic views showing that the present invention is used for mirror-image cutting.

### DETAILED DESCRIPTION OF THE PREFERRED EMBODIMENTS

Embodiments of the present invention will now be described, by way of example only, with reference to the accompanying drawings.

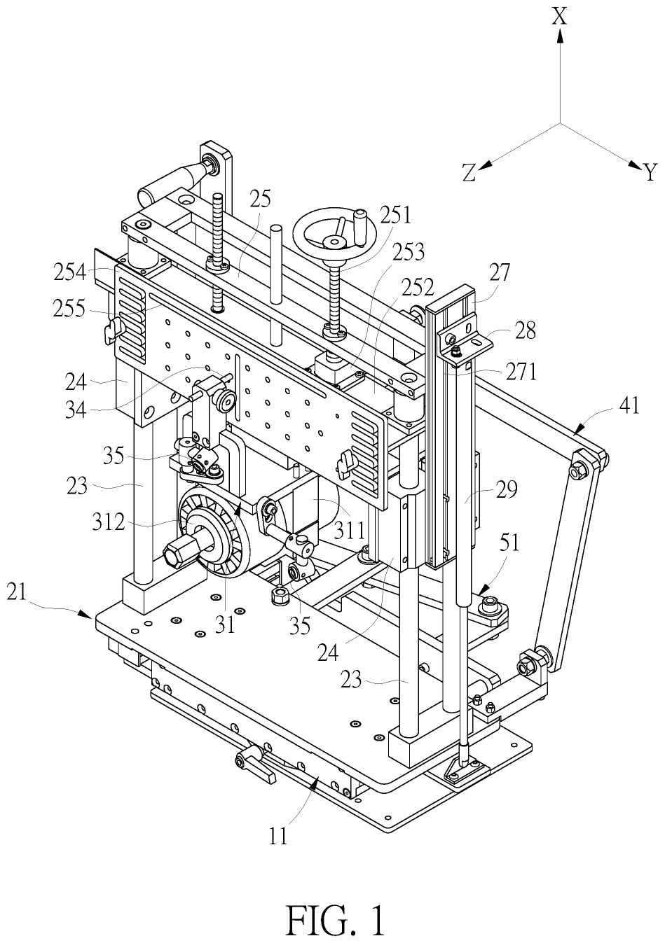

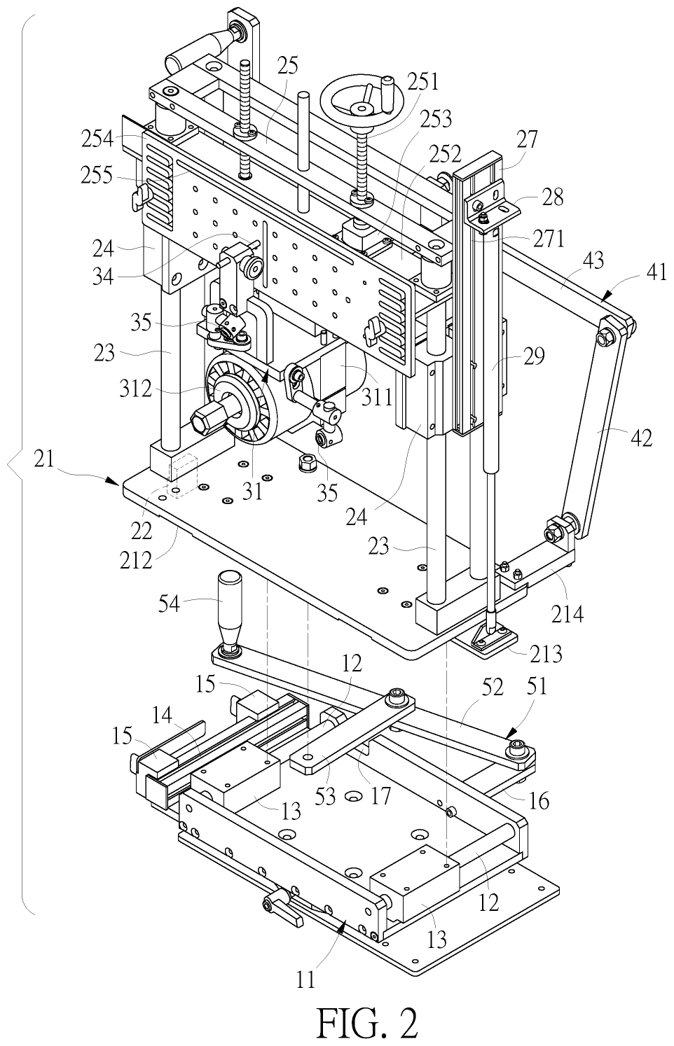

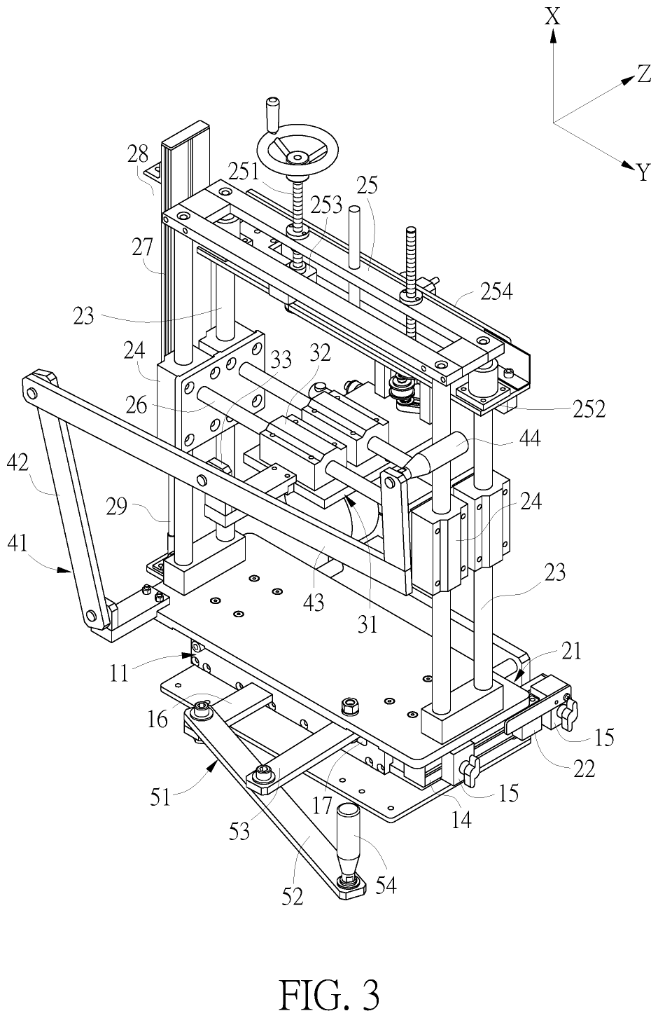

Referring to FIGS. 1-3, the present invention comprises a base 11, a sliding seat 21, a carrier 31, and a first swinging arm assembly 41.

The base 11 has two z-axis guide poles 12 arranged in parallel and extending in a z-axis direction. A z-axis slider 13 is slidably disposed on each of the two z-axis guide poles 12. One side of the base 11 is provided with a slide rail 14. Two limiting blocks 15 are slidably disposed on the slide rail 14 and spaced apart from each other.

The sliding seat 21 is in the form of a plate, and has a top surface 211 and a bottom surface 212. The bottom surface 212 of the sliding seat 21 is connected to the two z-axis sliders 13, and the sliding seat 21 is moveable in the z-axis direction relative to the base 11. One side of the sliding seat 21, relative to the two limiting blocks 15, is provided with a stop block 22. The stop block 22 is located between the two limiting blocks 15. When the sliding seat 21 drives the stop block 22 to move in the z-axis direction, the movement of the sliding seat 21 is restricted by adjusting the two limiting blocks 15.

The top surface 211 of the sliding seat 21 is provided with at least two longitudinal guide poles 23 arranged in parallel. Two longitudinal sliders 24 at the same height are slidably disposed on the two longitudinal guide poles 23, so that the two longitudinal sliders 24 can move along the two longitudinal guide poles 23 in an x-axis direction. At least one transverse guide pole 26 is connected between the two longitudinal sliders 24. An outer side of one of the longitudinal sliders 24 is provided with a pressing member 27. The pressing member 27 is provided with a rail groove 271 extending in the x-axis direction. A pressing plate 28 is disposed in the rail groove 271. The position of the pressing plate 28 is adjustable along the rail groove 271. A pneumatic cylinder 29 is vertically disposed on a coupling seat 213 of the sliding seat 21 in the x-axis direction. An upper end of the pneumatic cylinder 29 is connected to the pressing plate 28. The pneumatic cylinder 29 provides a buffering action when the two longitudinal sliders 24 are moved downward in the x-axis direction. The pneumatic cylinder 29 also provides an auxiliary upward thrust when the two longitudinal sliders 24 are moved upward. The pneumatic cylinder 29 makes the operation smooth. A top frame 25 is transversely fixed to the top ends of the two longitudinal guide poles 23. The top frame 25 is provided with a lifting screw rod 251 extending in the x-axis direction. A template seat 252 is disposed at a lower end of the lifting screw rod 251 passing through the top frame 25. The template seat 252 is provided with a position indicator 253 and a template 254. The lifting screw rod 251 passes through the position indicator 253 to be connected to the template seat 252. Two opposite sides of the template seat 252 are slidably connected to the two longitudinal guide poles 23. Rotating the lifting screw rod 251 can drive the template seat 252 to move up and down along the two longitudinal guide poles 23. The position indicator 253 can detect and display the movement distance of the template seat 252 as a basis for calculation in subsequent machining, thereby ensuring the machining accuracy.

At least one transverse slider 32 is fixed on the carrier 31. The transverse slider 32 of the carrier 31 is slidably connected to the transverse guide pole 26, so that the carrier 31 can slide in the x-axis direction along with the two longitudinal sliders 24 or in a y-axis direction along with the transverse guide pole 26. The template seat 252 is located between the top frame 25 and the carrier 31. In this embodiment, the bottom of the carrier 31 is connected with a spindle holder 311. The spindle holder 311 is provided with a spindle 312. The top of the carrier 31 is provided with a probe 34. Two infrared aligners 35 are disposed on two adjacent sides of the carrier 31. The two infrared aligners 35 are spaced apart from each other at an angle of 90 degrees to project a crisscross mark line for marking the position of the cutting center of the spindle 312, so that the center of a workpiece (not shown) is calibrated.

The first swinging arm assembly 41 is composed of a first lever 42 and a second lever 43. The first lever 42 is pivotally connected to a first pivot seat 214 of the sliding seat 21. The first pivot seat 214 extends in the Z-axis direction toward the first swinging arm assembly 41. A lower end of the first lever 42 is pivotally connected to the first pivot seat 214, and an upper end of the first lever 42 is pivotally connected to one end of the second lever 43. A middle portion of the second lever 43 is pivotally connected to a second pivot seat 33 of the carrier 31. The distal end of the second lever 43 is bent to form a first grip portion 44. The second pivot seat 33 also extends in the Z-axis direction toward the first swinging arm assembly 41.

Furthermore, one side of the base 11, facing the first swinging arm assembly 41, is provided with a connecting rod 16 extending outwardly. The connecting rod 16 is connected with a second swinging arm assembly 51. The second swinging arm assembly 51 is composed of a push lever 52 and a top lever 53. One end of the push lever 52 is transversely pivotally connected to the connecting rod 16 of the base 11, and another end of the push lever 52 is bent to form a second grip portion 54. One end of the top lever 53 is pivotally connected to a middle portion of the push lever 52, and another end of the top lever 53 passes through a notch 17 of the base 11 and is pivotally connected to the bottom surface 212 of the sliding seat 21.

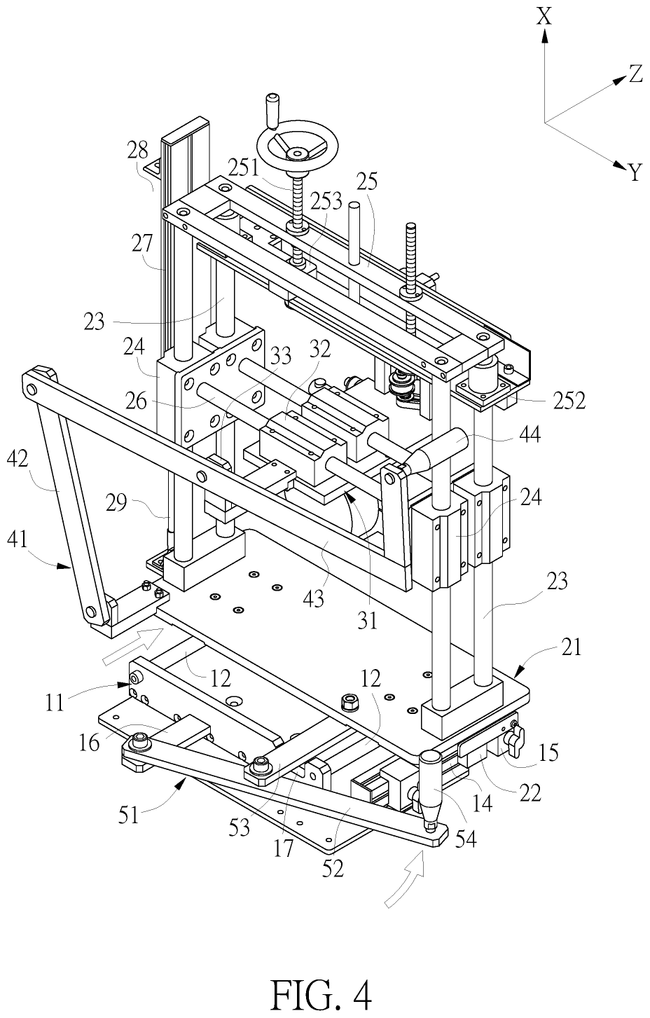

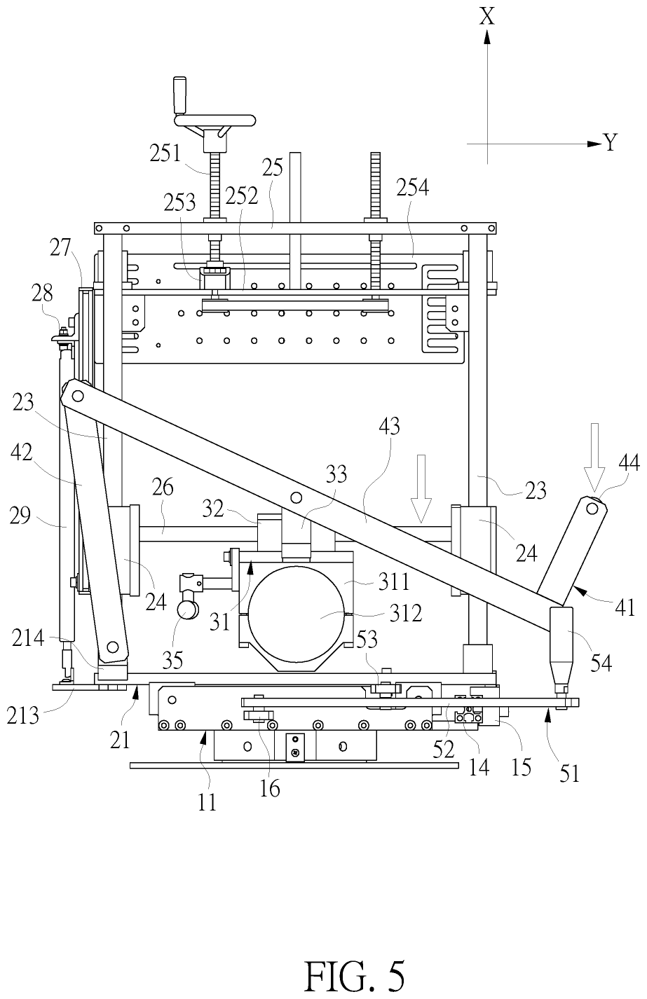

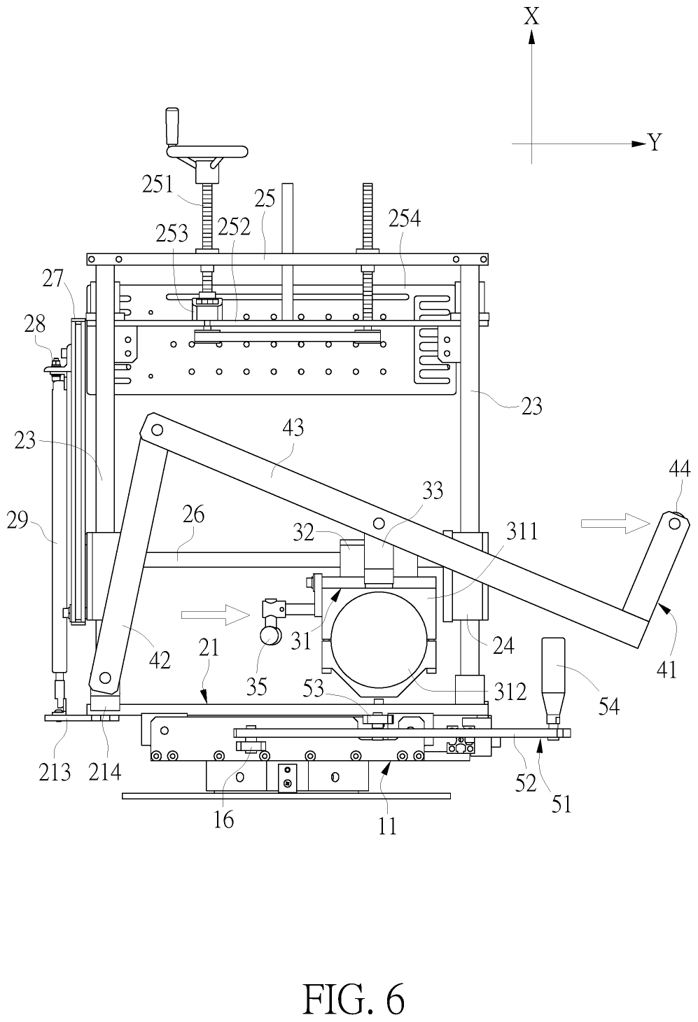

Referring to FIGS. 4-6, in use, the operator holds the first grip portion 44 and the second grip portion 54 with both hands to directly push and pull the first swinging arm assembly 41 and the second swinging arm assembly 51, so that the carrier 31 is driven to move in the x-axis direction, the y-axis direction or the z-axis direction. As shown in FIG. 4, when the operator holds the second grip portion 54 with one hand to push forward, the top lever 53 is moved forward through the push lever 52 of the second swinging arm assembly 51, and the sliding seat 21 is pushed by the top lever 53, so that the sliding seat 21 and the carrier 31 mounted on the sliding seat 21 are synchronously driven to move in the z-axis direction. As shown in FIG. 5, when the operator holds the first grip portion 44 by another hand and applies a force to press it down, the second pivot seat 33 pivotally connected to the second lever 43 is driven to move the carrier 31 down along the two longitudinal guide poles 23 in the x-axis direction. As shown in FIG. 6, when the operator pushes the first grip portion 44 rightward, the second lever 43 is pulled rightward and the second pivot seat 33 is driven to move the carrier 31 rightward along the transverse guide pole 26 in the y-axis direction. Thereby, the operator can operate the first swinging arm assembly 41 and the second swinging arm assembly 51 to drive the carrier 31 to move up, down, left and right, so that the probe 34 of the carrier 31 is movable along a predetermined contour on the template 254 for imitating a cutting process.

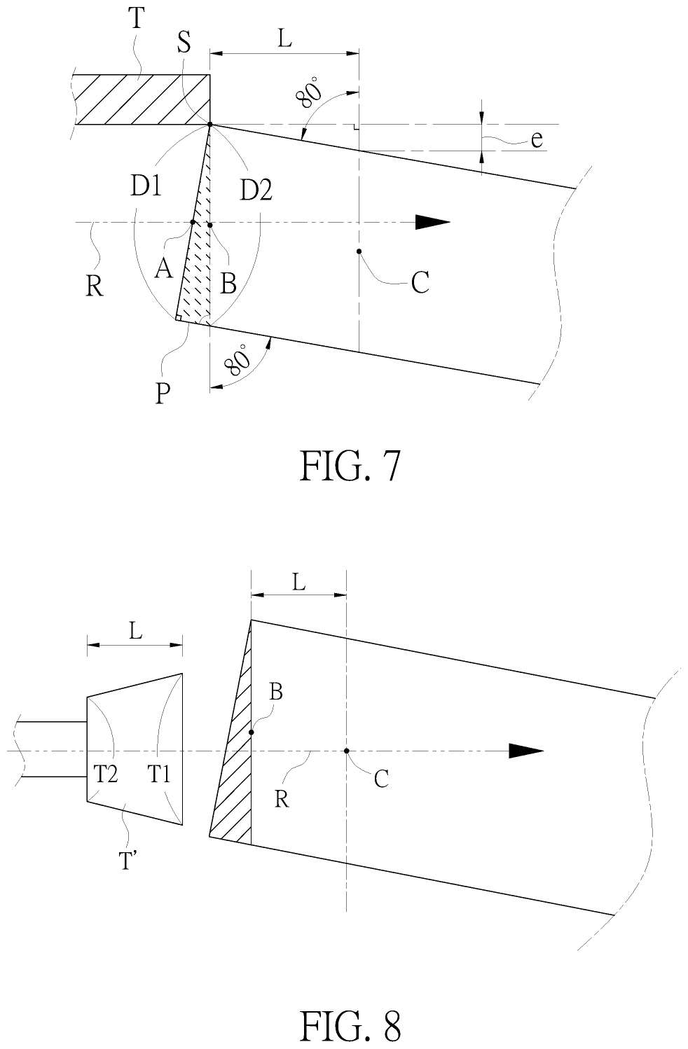

In use, the probe 34 on the carrier 31 is inserted into a transverse slot 255 of the template 254. When the lifting screw rod 251 drives the template seat 252 to move up and down, the carrier 31 is synchronously driven to move up and down. Through the position indicator 253, the displacement value of the spindle 312 of the carrier 31 can be known as a basis for calculation in subsequent machining, so that the calculation for the center point of the skew angle is more simple and accurate. For example, when the user wants to cut a skew angle of 10 degrees at the end portion of a cylindrical workpiece that has been tilted by 10 degrees, as shown in FIG. 7, if the diameter D1 of the end face of the end portion P of the workpiece is 40 mm. When a skew surface with an inclination angle of 10 degrees is to be further cut, the cutter T mounted on the spindle 312 is first in contact with the end portion P of the workpiece, defined as a starting point S. Through the trigonometric function formula of

$$csc 80 = \frac{D 2}{40} ,$$

the diameter D2 of the end face after cutting is calculated as 40.6 mm. It can be known that the center offset value of the diameter D2 of the end face after cutting is 0.61 mm by the center offset value conversion table (shown in Table 1) which is firstly obtained by the trigonometric formula.

TABLE 1
Center offset value conversion table for a cylindrical workpieces
with a diameter of 40 mm

| | cylindrical workpiece (40 mm) | | | | |
|---|---|---|---|---|---|
| | 10° | 11° | 12° | 13° | 14° |
| offset value (mm) | 0.61 | 0.74 | 0.88 | 1.04 | 1.21 |

Then, the two infrared aligners 35 project a crisscross mark line R to pre-position the center position A of the front end face to be cut. If the displacement value displayed by the position indicator 253 is 50 mm at this time, the user can adjust the displacement value of the position indicator 253 to 50.61 mm (i.e., 50 mm+0.61 mm) by directly adjusting the lifting screw rod 251, that is, the center position of the end portion P of the workpiece after cutting is positioned accurately. Then, when the length L of the tenon to be machined is 30 mm, the center offset value e is calculated to be 5.29 mm by the trigonometric function formula of

$$tan 80 = \frac{30}{e}$$

when the cutting length is 30 mm. Because the position indicator 253 displays that the center position B of the end portion P of the workpiece after cutting is 50.61 mm, it is only necessary to adjust the lifting screw rod 251 again, and the displacement value of the position indicator 253 is adjusted to 55.9 mm (i.e., 50.61 mm+5.29 mm), that is, the center position C of the end portion P of the workpiece at a cutting length of 30 mm is positioned accurately. This way can quickly calculate the position of the center point of the skew angle for subsequent machining and is advantageous for the cutting operation of the skew angle to ensure its machining accuracy.

Furthermore, the calculation method for positioning the center point of the workpiece of the present invention may be applied to the manufacture of a dovetail-shaped tenon with a skew angle. For example, when the user wants to cut the end face of a wooden board that has been inclined at a predetermined angle to have a dovetail-shaped tenon, firstly, the offset value of the center position B and the offset value of the center position C are respectively obtained by using the aforementioned calculation method. When the workpiece is a wooden board with a thickness of 25 mm, the offset value of the center position B is obtained by the center offset value conversion table (shown in Table 2) which is firstly obtained by the trigonometric formula.

TABLE 2
Center offset value conversion table for a wooden board
with a thickness of 25 mm

| | wooden board (25 mm) | | | | |
|---|---|---|---|---|---|
| | 10° | 11° | 12° | 13° | 14° |
| offset value (mm) | 0.38 | 0.46 | 0.55 | 0.65 | 0.75 |

As shown in FIG. 8, a dovetail-shaped cutter T′ is mounted on the spindle 312, and the large diameter end T1 of the dovetail-shaped cutter T′ is 19.1 mm, the small diameter end T2 of the dovetail-shaped cutter T′ is 13.12 mm, and the length of the blade is 12 mm. When the length L of the dovetail-shaped tenon to be machined is 12 mm, the offset value of the center position C when the machining length is 12 mm can be obtained by the aforementioned calculation method. Then, the two infrared aligners 35 project a crisscross mark line R to align the cutting center of the dovetail-shaped cutter T′ with the center position C. If the displacement value displayed by the position indicator 253 is 50 mm at this time, the offset value F of the cutting center of the dovetail-shaped cutter T′ is calculated to be 16.11 mm by the formula of

$$\frac{T 1 + T 2}{2} .$$

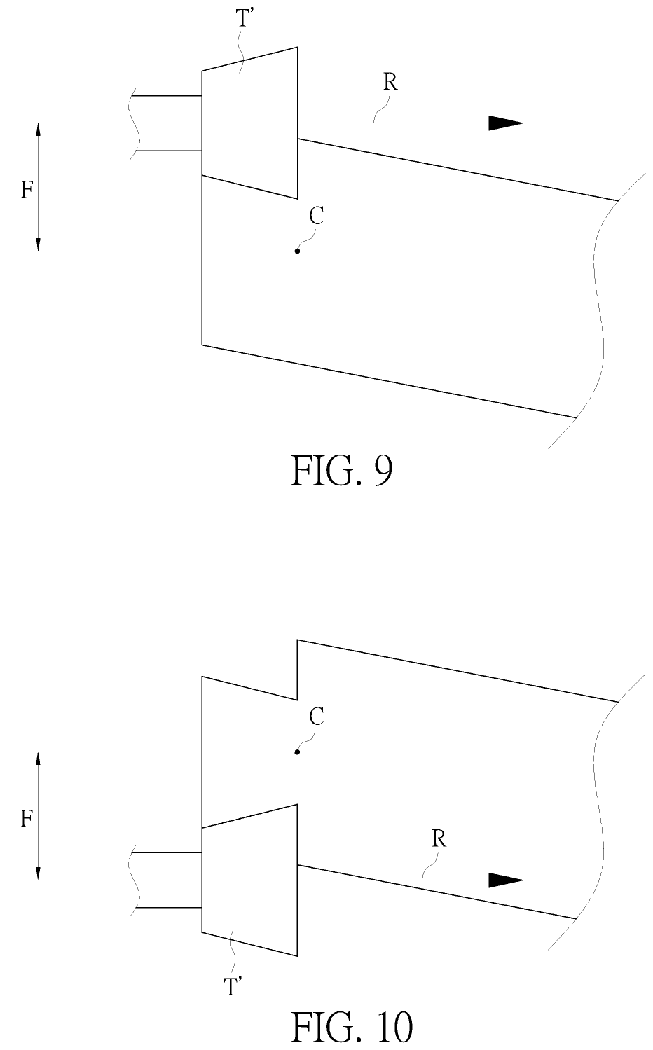

After that, the user can move the cutting center of the dovetail-shaped cutter T′ to 33.89 mm (i.e., 50-16.11 mm) by adjusting the lifting screw rod 251, that is, the upper half of the dovetail-shaped tenon can be cut and formed (as shown in FIG. 9). Then, by adjusting the lifting screw rod 251 to move the cutting center of the dovetail-shaped cutter T′ to 66.11 mm (i.e., 50+16.11 mm), the lower half of the of the dovetail-shaped tenon can be cut and formed (as shown in FIG. 10). Thereby, the half of the dovetail-shaped cutter T′ can be offset up and down, and the dovetail-shaped tenon can be quickly reproduced by mirror-image cutting. Through the carrier structure of the present invention, it is easy to machine a dovetail-shaped tenon with a skew angle. The two infrared aligners 35 cooperate with the position indicator 253 to ensure the machining accuracy.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A carrier structure of a woodworking machine spindle, comprising:
a base;
a sliding seat, having a top surface and a bottom surface, the bottom surface of the sliding seat being slidably disposed on the base, the sliding seat being moveable in a z-axis direction relative to the base, the top surface of the sliding seat being provided with at least two longitudinal guide poles arranged in parallel, two longitudinal sliders being slidably disposed on the two longitudinal guide poles so that the two longitudinal sliders are movable along the two longitudinal guide poles in an x-axis direction, at least one transverse guide pole being connected between the two longitudinal sliders, a top frame being transversely fixed to top ends of the two longitudinal guide poles, the top frame being provided with a lifting screw rod extending in the x-axis direction, a template seat being disposed at a lower end of the lifting screw rod passing through the top frame, the template seat being provided with a position indicator, the lifting screw rod passing through the position indicator to be connected to the template seat, two opposite sides of the template seat being slidably connected to the two longitudinal guide poles, rotating the lifting screw rod driving the template seat to move along the two longitudinal guide poles;
a carrier, having a transverse slider, the transverse slider of the carrier being slidably connected to the transverse guide pole so that the carrier is moveable in the x-axis direction along with the two longitudinal sliders or in a y-axis direction along with the transverse guide pole, a bottom of the carrier being connected with a spindle holder, the spindle holder being provided with a spindle, two infrared aligners being disposed on two adjacent sides of the carrier, the two infrared aligners being spaced apart from each other at an angle of 90 degrees to project a crisscross mark line for marking a position of a cutting center of the spindle.

2. The carrier structure of the woodworking machine spindle as claimed in claim 1, wherein the base has two z-axis guide poles arranged in parallel and extending in the z-axis direction, a z-axis slider is slidably disposed on each of the two z-axis guide poles, and the bottom surface of the sliding seat is connected to the two z-axis sliders so that the sliding seat is movable in the z-axis direction relative to the base.

3. The carrier structure of the woodworking machine spindle as claimed in claim 1, wherein one side of the base is provided with a slide rail, two limiting blocks are disposed on the slide rail and spaced apart from each other, one side of the sliding seat, relative to the two limiting blocks, is provided with a stop block, the stop block is located between the two limiting blocks, when the sliding seat drives the stop block to move in the z-axis direction, a movement of the sliding seat is restricted by adjusting the two limiting blocks.

4. The carrier structure of the woodworking machine spindle as claimed in claim 1, further comprising a first swinging arm assembly, the first swinging arm assembly being composed of a first lever and a second lever, one end of the first lever being pivotally connected to the sliding seat, another end of the first lever being pivotally connected to the second lever, a middle portion of the second lever being pivotally connected to the carrier, a distal end of the second lever is bent to form a first grip portion.

5. The carrier structure of the woodworking machine spindle as claimed in claim 4, wherein one side of the base, facing the first swinging arm assembly, is provided with a connecting rod extending outwardly, the connecting rod is connected with a second swinging arm assembly, the second swinging arm assembly is composed of a push lever and a top lever, one end of the push lever is transversely pivotally connected to the connecting rod of the base, another end of the push lever is bent to form a second grip portion, one end of the top lever is pivotally connected to a middle portion of the push lever, and another end of the top lever passes through a notch of the base and is pivotally connected to the sliding seat.

6. The carrier structure of the woodworking machine spindle as claimed in claim 1, wherein an outer side of one of the longitudinal sliders is provided with a pressing member, the pressing member is provided with a rail groove extending in the x-axis direction, a pressing plate is disposed in the rail groove, the pressing plate is adjustable along the rail groove, a pneumatic cylinder is vertically disposed on a coupling seat of the sliding seat in the x-axis direction, and an upper end of the pneumatic cylinder is connected to the pressing plate.
